(19) United States
(12) Patent Application Publication
(10) Pub. No.: US 2024/0303536 A1
(43) Pub. Date: Sep. 12, 2024

(54) Machine Learning with Data Driven Optimization Using Iterative Neighborhood Selection

(71) Applicant: International Business Machines Corporation, Armonk, NY (US)

(72) Inventors: Dharmashankar Subramanian, White Plains, NY (US); Nianjun Zhou, Chappaqua, NY (US)

(21) Appl. No.: 18/179,856

(22) Filed: Mar. 7, 2023

(51) Int. Cl. G06N 20/00

(52) U.S. Cl. CPC G06N 20/00

(57) ABSTRACT

A computer implemented method for data driven optimization. A number of processor units creates a regression model using historical data in a current neighborhood. The historical data is for a system over time. The number of processor units generates an optimization solution using the regression model created from the current neighborhood and an objective function. The number of processor units determines whether the optimization solution is within the current neighborhood. The number of processor units selects a new neighborhood containing the historical data in response to the optimization solution not being within the current neighborhood. The new neighborhood is based on the optimization solution and becomes the current neighborhood. The number of processor units repeats the creating, generating, determining, and selecting steps in response to the optimization solution not being within the current neighborhood.

### BACKGROUND

The disclosure relates generally to an improved computer system and more specifically to a computer implemented method, apparatus, system, and computer program product for data driven optimization using iterative neighborhood selection.

Manufacturing and industrial companies may use digital semantic representations of the physical manufacturing world in managing operations of assets. These digital representations of assets can be for a refinery, a manufacturing plant, a production plant, a building, a supply chain network, or other systems. With the use of sensor networks having high bandwidth, large amounts of data can be gathered from the systems for use in predictive analytics and optimization. This type of analysis can provide up-to-date situation awareness and enable companies to take steps to optimize their operations.

With this type of analysis, a data driven regression optimization can use machine learning models and optimization techniques to optimize setpoints for process controls for individual processes or a system for plantwide level. This optimization can be used to optimize production processes such as refining, manufacturing, inspection, or other processes.

The production processes for companies can have complex sequences of processes. Each of these processes can have inputs and outputs. A complex relationship can be present between various setpoints, material inflows, and the throughput and quality of the output. A data driven approach can be utilized to represent complex relationships through regression modeling, serving as a surrogate to physical or chemical models that are based on physical principles. The set points can be selected for control variables to influence the output of a system.

With the large amount of data available, data driven optimization of regression-based machine learning can be used to identify setpoints for control variables in these processes to obtain desired output. For example, a regression model can be used to maximize production flow in a physical and chemical process such as refining oil sands. With this refining process, oil sands can be input into a refinery that processes this input to create products. These products can be, for example, asphalt, gasoline, diesel, lubricants, kerosene, and other products. The refinery can include various processes such as bitumen extraction that limit upgrading and crude oil refining. These processes can have independent variables that result in the output for final products using an objective and an optimizer.

The optimization performed can be a real time production optimization in response to changing plants and market conditions. Vast amounts of sensor data can be captured that are relevant to determining input and output relationships. This data can be used with optimization models to compute setpoints for control variables over a lookahead horizon to optimize different performance metrics. These performance metrics can be, for example, yield, throughput, production rate, and other types of metrics. With the determination of setpoints for control variables in various processes, sensor data can be used to continuously learn the behavior of processes in a system to provide updated setpoints for obtaining desired output in the near real time.

With data driven optimization, a regression model can be created to approximate an objective function or a constraint in a physical or chemical process as a function of control variables and non-control variables using the historical harvest sensor and other data. The non-control variables are those process variables that change a rate that is sufficiently slow that these variables can be treated as constants for optimization solutions. The regression model serves as a surrogate function of the objective function or the constraint left-hand-side in the physical or chemical process of interest. The objective of the optimization is a mathematical representation the reflects the values of the outputs of the process. The regression model based optimization can optimize the objective using mathematical optimization techniques. However, these models may not provide a desired level of accuracy if not used properly.

### SUMMARY

According to one illustrative embodiment, a computer implemented method for data driven optimization is provided. A number of processor units creates a regression model using historical data in a current neighborhood. The historical data is for a system over time. The number of processor units generates an optimization solution using the regression model created from the current neighborhood and an objective function. The number of processor units determines whether the optimization solution is within the current neighborhood. The number of processor units selects a new neighborhood containing the historical data in response to the optimization solution not being within the current neighborhood having a sufficient level of accuracy. The new neighborhood is based on the previous optimization solution and becomes the current neighborhood. The number of processor units repeats the creating, generating, determining, and selecting steps in response to the optimization solution not being within the current neighborhood.

According to other illustrative embodiments, a computer system and a computer program product for data driven optimization are provided. As a result, the illustrative embodiments generate an optimization solution using an iterative process based on whether the optimization solution is in the same neighborhood as the neighborhood used to create the regression model in a manner that increases the accuracy and confidence in the optimization solution.

The illustrative embodiments can permissively select a region for the new neighborhood to encompass a number of the historical data points that results in the regression model generating predictions within a threshold value when making the predictions using test data. As a result, the illustrative embodiments can provide a technical effect of increasing the performance in generating an optimization solution that more closely models an actual response of the system.

The illustrative embodiments can permissively increase a size of a region for the new neighborhood in response to a selected number of iterations in generating the optimization solution occurring without the new neighborhood for the optimization solution being within the current neighborhood used to create the regression model. As a result, the illustrative embodiments can provide a technical effect of obtaining an improved optimization solution to in which alignment is present between the regression models and the optimization solution.

The illustrative embodiments can permissively determine a number of historical data points present in an overlap between the new neighborhood for the optimization solution and the current neighborhood used to create the regression model in response to the new neighborhood not being within the current neighborhood and the overlap being present between the new neighborhood and the current neighborhood and use the optimization solution in response to the number of the historical data points being greater than a threshold for historical data points needed for the regression model. Thus, the illustrative embodiments can provide a technical effect of identifying an optimization solution with a number of iterations through considering an overlap between the current neighborhood used the create the regression model and the new neighborhood for the optimization solution.

### BRIEF DESCRIPTION OF THE DRAWINGS

FIG. 1 is a block diagram of a computing environment in accordance with an illustrative embodiment;

FIG. 2 is a block diagram of a model environment in accordance with an illustrative embodiment;

FIG. 3 is an optimization model used to generate an optimization solution in accordance with an illustrative embodiment;

FIG. 4 is a diagram of neighborhoods used in an iterative process for generating an optimization solution in accordance with an illustrative embodiment;

FIG. 5 is a flowchart of a process for data driven optimization in accordance with an illustrative embodiment;

FIG. 6 is a flowchart of a process for selecting a new neighborhood in accordance with an illustrative embodiment;

FIG. 7 is a flowchart of a process for selecting a new neighborhood in accordance with an illustrative embodiment;

FIG. 8 is a flowchart of a process for changing a region size for a new neighborhood in accordance with an illustrative embodiment;

FIG. 9 is a flowchart of a process for changing a region size for a new neighborhood in accordance with an illustrative embodiment;

FIG. 10 is a flowchart of a process for determining whether an optimization solution is within a current neighborhood in accordance with an illustrative embodiment;

FIG. 11 is a flowchart of a process for determining whether an optimization solution is within a current neighborhood in accordance with an illustrative embodiment;

FIG. 12 is a flowchart of a process for determining whether an optimization solution is within a current neighborhood in accordance with an illustrative embodiment;

FIG. 13 is a flowchart of a process for repulsing iterations in generating optimization solutions is depicted in accordance with an illustrative embodiment;

FIG. 14 is a flowchart of a process for data driven optimization in accordance with an illustrative embodiment; and

FIG. 15 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals Beltway flight leg late of the very thing you is now the well he is the 50 and that was the end of their label 5 communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

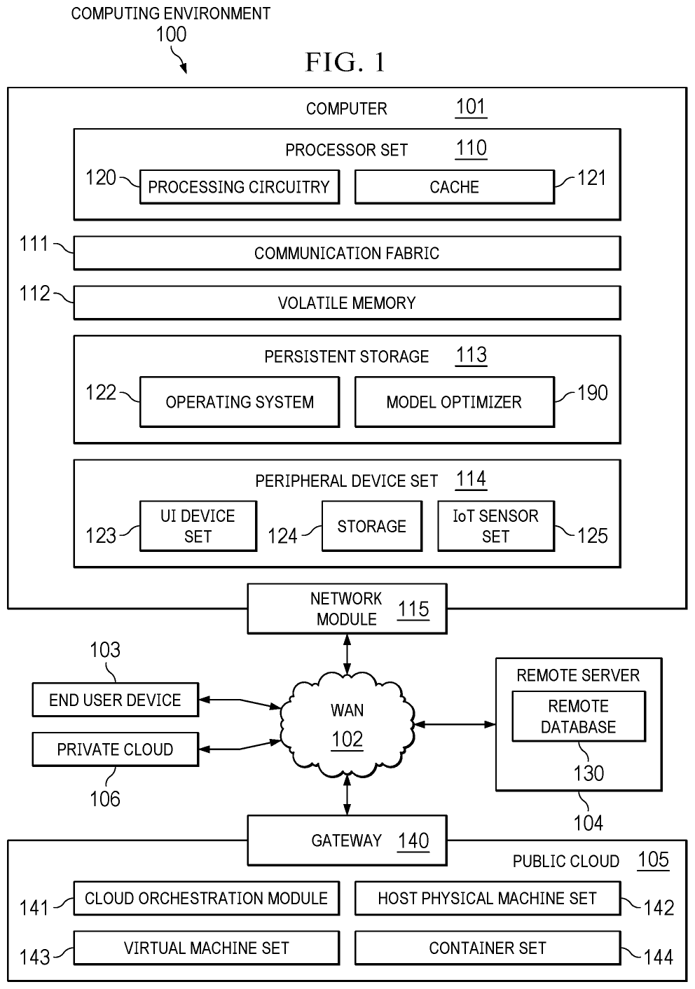

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as model optimizer 190. In this example, model optimizer 190 can operate to manage at least one of the creation or optimization of machine learning models. In the different illustrative examples, model optimizer 190 can operate to apply regression models into an optimization process for data driven model optimization.

In addition to model optimizer 190, computing environment 100 includes, for example, computer 101, wide area network (WAN) 102; end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and model optimizer 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in model optimizer 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in model optimizer 190 includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, a mathematical optimization of the surrogate function may select an optimization solution in a region of training data that is not well supported by the training data in that region for use in creating a regression model. In other words, the amount of data in the region for the optimization solution may be sparse or have insufficient data points to provide a desired level of confidence in the optimization solution. Further, this mathematical optimization may also have poor regression function quality. As a result, the optimization solution is not desirable because of a lack of confidence in the function approximation occurring through a lack of observations in the region.

Additionally, the illustrative embodiments recognize and take into account that a systematic error between a regression model and current plant conditions can occur when the prediction occurs using an optimization model created using current techniques. This systematic error can be a mismatch between the prediction of variables for a system and the actual response of the system. Further, with a long-term regression model, statistical properties in the current operational state of the system may be significantly different from the overall historical statistical properties. Thus, a systematic error can occur when a single static model is used to model the process. Further, a local or short-term regression model can provide a suggestion to change the current practice and adopt a different operational mode to obtain an optimal solution.

As result, the use of data driven regression can lead to unexpected inconsistencies. These inconsistencies can occur with a systematic error between the models and current conditions, a mismatch between the projection and the actual response, and a sensitivity of values used for non-control variables.

The illustrative embodiments recognize and take account that regression optimization should be performed jointly. The illustrative examples provide a computer implemented method, apparatus, computer system, and computer program product for data driven optimization to obtain optimization solutions.

In an illustrative example, a regression model is created, and an optimization solution is generated using the regression model and an objective function. The neighborhood of the optimization solution is compared to the neighborhood of data used to generate the regression model. If the optimization solution is outside of the neighborhood for the regression model, a new neighborhood is created around the optimization solution. This new neighborhood is used to create a new regression model, which in turn is used to generate a new optimization solution. This process can be repeated until the optimization model is within the neighborhood of the data used for the regression model.

In this illustrative example, the process can end after repeating this process some number of times if optimization solution does not end up being within the neighborhood of data used to create the regression model. In another illustrative example, the size of the neighborhood around the optimization solution can be increased when the amount of data in the new neighborhood selected based on the optimization solution is sparse. In yet another illustrative example, the neighborhood size can also be increased when the optimization solution does not fall within the neighborhood of the regression model.

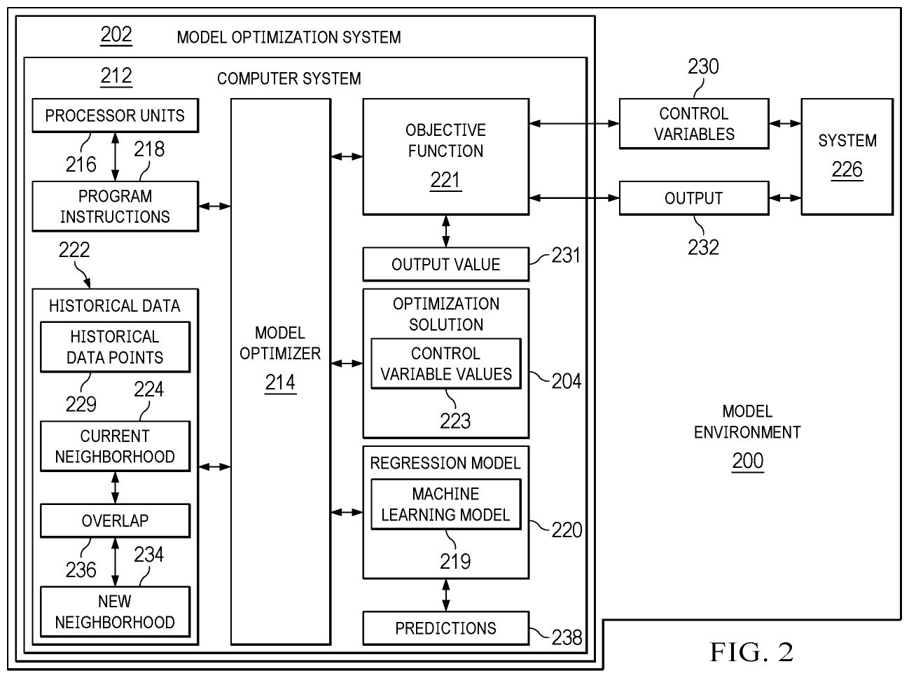

With reference now to FIG. 2, a block diagram of a model environment is depicted in accordance with an illustrative embodiment. In this illustrative example, model environment 200 includes components that can be implemented in hardware such as the hardware shown in computing environment 100 in FIG. 1.

In this illustrative example, model optimization system 202 in model environment 200 can be used generate optimization solution 204. This optimization solution can be used to manage at least one of a process or a system.

Model optimization system 202 comprises a number of different components. As depicted, model optimization system 202 comprises computer system 212 and model optimizer 214. Model optimizer 214 is located in computer system 212.

Model optimizer 214 can be implemented in software, hardware, firmware or a combination thereof. When software is used, the operations performed by model optimizer 214 can be implemented in program instructions configured to run on hardware, such as a processor unit. When firmware is used, the operations performed by model optimizer 214 can be implemented in program instructions and data and stored in persistent memory to run on a processor unit. When hardware is employed, the hardware can include circuits that operate to perform the operations in model optimizer 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program instructions that operate a computer. A processor unit can be implemented using processor set 110 in FIG. 1. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different type of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, model optimizer 214 can perform data driven optimization in generating optimization solution 204. In this illustrative example, model optimizer 214 creates regression model 220 using historical data 222 in current neighborhood 224.

Regression model 220 is a set of statistical processes for estimating the relationships between control variables 230 and output 232 for system 226. Control variables 230 and output 232 can be for one or more processes in system 226. In this example, regression model 220 is implemented using machine learning model 219.

A machine learning model is a type of artificial intelligence model that can learn without being explicitly programmed. A machine learning model can learn based on training data input into the machine learning model. The machine learning model can learn using various types of machine learning algorithms. The machine learning algorithms include at least one of a supervised learning, and unsupervised learning, a feature learning, a sparse dictionary learning, an anomaly detection, a reinforcement learning, a recommendation learning, or other types of learning algorithms. Examples of machine learning models include an artificial neural network, a convolutional neural network, a decision tree, a support vector machine, a regression machine learning model, a classification machine learning model, a random forest learning model, a Bayesian network, a genetic algorithm, and other types of models. These machine learning models can be trained using data and process additional data to provide a desired output.

In this illustrative example, historical data 222 is for system 226 over time. This data may also be referred to as time series historical data.

System 226 can take a number of different forms. System 226 can be, for example, a physical system. This physical system can be, for example, a plant, a refinery, a chemical plant, a manufacturing facility, a building, a data center, a supply chain network, or some other type of physical system. This historical data can be generated from sensors that monitor system 226.

The sensors can be located in, on, or proximate to system 226 such that the sensors can generate sensor data over time. This sensor data is sent to model optimizer 214 for storage as historical data points 229 in historical data 222. Historical data 222 can be time series data representing different states of system 226 over time. These historical data points can be for control variables 230 such as a temperature, an air pressure, a fluid pressure, a torque, a humidity, a flow rate, a presence of chemicals, a magnetic field, an electric field, a sound level, an air flow, and other variables for properties that can be measured for system 226.

In this example, model optimizer 214 generates optimization solution 204 using regression model 220 and objective function 221. In this example, optimization solution 204 comprises control variable values 223 for control variables 230 in objective function 221 used to obtain an extrema as output value 231 of objective function 221. In this example, the extrema is a maximum value for the minimum value that can be obtained as an output from objective function 221 using regression model 220.

In some illustrative examples, output value 231 can be included as part of optimization solution 204. In other examples, output value 231 can be determined using control variable values 223 and objective function 221.

In this illustrative example, model optimizer 214 determines whether optimization solution 204 is within current neighborhood 224. As described, current neighborhood 224 is the neighborhood used to create objective function 221. A neighborhood is a region of historical data. This region can be defined by a plurality of dimensions in the historical data. In this example, current neighborhood 224 is the region of historical data 222 used to create objective function 221.

In this illustrative example, one manner in which a determination can be made as to whether optimization solution 204 is within current neighborhood 224 is to determine if control variable values 223 and output value 231 are within current neighborhood 224. In another example, model optimizer 214 can select new neighborhood 234 for optimization solution 204. Model optimizer 214 can determine whether new neighborhood 234 for optimization solution 204 is within current neighborhood 224 used to create regression model 220 in determining whether optimization solution 204 is within current neighborhood 224.

If new neighborhood 234 is within current neighborhood 224, then objective function 221 is considered to be in current neighborhood 224. In this case, model optimizer 214 has completed optimization of optimization solution 204. Optimization solution 204 can be used to operate system 226.

In another illustrative example, new neighborhood 234 is not within current neighborhood 224 but overlap 236 is present between new neighborhood 234 and current neighborhood 224. Model optimizer 214 can determine a number of historical data points 229 in historical data 222 present in overlap 236 between new neighborhood 234 for optimization solution 204 and current neighborhood 224 used to create regression model 220 in response to new neighborhood not being within current neighborhood 224 and overlap 236 being present between new neighborhood 234 and the current neighborhood 224. Optimization solution 204 can be used to control system 226 in response to the number of historical data points 229 being greater than a threshold for historical data points needed for the regression model. The number of data points needed in this overlap can be based on the number of data points that are sufficient for the creation of regression model 220 used to create optimization solution 204.

Model optimizer 214 selects new neighborhood 234 containing the historical data in response to the optimization solution being outside the current neighborhood having the sufficient level of accuracy. In this example, new neighborhood 234 is based on optimization solution 204 and becomes current neighborhood 224 for creating regression model 220 as part of an iterative process.

In selecting new neighborhood 234, model optimizer 214 can select new neighborhood 234 as a region around optimization solution 204 that encompasses historical data points 229 in historical data 222. In this example, optimization solution 204 is a center of new neighborhood 234. This center can be a geometric center for new neighborhood 234. For example, the center can be the center of an area or volume for the region for new neighborhood 234.

In this illustrative example, the region for new neighborhood 234 can be selected by model optimizer 214 to encompass a number of historical data points 229 that results in regression model 220 generating predictions 238 within threshold value when making predictions 238 using test data. In this example, a threshold value is a level of accuracy for predictions 238. When the level accuracy is not sufficient, the size of the region for new neighborhood 234 can be increased. The accuracy can be determined using test data. It is desirable to have a density of historical data points 229 that are considered dance with respect to statistical criteria on how much data is needed to build regression model 220. As the density of historical data points 229 increases, the ability to generate predictions 238 within threshold value increases.

This new neighborhood becomes current neighborhood 224 for use in creating regression model 220. In other words, regression model 220 can be re-created using historical data points 229 selected for new neighborhood 234. In this manner, regression model 220 can be re-created with a different set of historical data points 229.

In this example, model optimizer 214 can repeat the steps of creating regression model 220, determining whether optimization solution 204 is within current neighborhood 224, and selecting new neighborhood 234 to become current neighborhood 224 for creating regression model 220 in this iterative process. These steps can be repeated in response to optimization solution 204 not being within the current neighborhood 224.

Model optimizer 214 can increase a size of a region for new neighborhood 234 in response to a number of historical data points 229 in new neighborhood 234 being less than a creation threshold. Creation threshold can be some number of historical data points such as 100 historical data points. The selection of creation threshold can be made using various statistical models to determine when sufficient historical data points are present for creating models such as regression model 220.

In another example, the size of the region for new neighborhood 234 can also be increased in response to a selected number of iterations in generating optimization solution 204 occur without new neighborhood 234 for optimization solution 204 being within current neighborhood 224 used to create regression model 220. Increasing the size of the region for new neighborhood 234 can reduce an issue with the iterative process never ending because the new neighborhood 234 is never within current neighborhood 224. By increasing the size of new neighborhood 234, at some point new neighborhood 234 will be within current neighborhood 224 or overlap 236 can be present with sufficient historical data points 229 to halt the iterative process and use optimization solution 204 to control system 226.

With completing optimization of optimization solution 204, optimization solution 204 can be stored in a database or other structure in a storage system accessible through a network. A user such as a person or control process for system 226 can automatically receive optimization solution 204 in response to an event. The event can be a request made by the user for optimization solution 204, a change in optimization solution 204, or some other event. Thus, optimization solution 204 can be used to control processes in a physical real-world system such as system 206.

In one illustrative example, one or more solutions are present that overcome a problem with generating an optimization solution with a desired level of accuracy. As a result, one or more solutions provide an effect increasing the accuracy of an optimization solution by generating the optimization solution in conjunction with the creation of a regression model. In other words, the evaluation of the optimization solution can be made based on the historical data used to create the regression model and the location of the optimization solution with respect to this historical data.

One or more solutions are present in which an iterative process is used to create a regression model, generate an optimization solution using the regression model, and determine whether the optimization solution is in a neighborhood of historical data points that falls within the current neighborhood used to create the regression model. The process is repeated using the neighborhood of the optimization solution as the current neighborhood to repeat creating the regression model and the optimization solution based using the regression model. This iterative process can be repeated until the optimization solution has a neighborhood that is located within the current neighborhood used to create the regression model from which the optimization solution was generated. This increases the accuracy and reliability of the optimization model with respect to modeling a physical real-world system such as a physical plant, refinery, building, or other system.

As a result, the different illustrative examples can use regression models that agree with the current state of a system. The iterative approach to the regression model creation and optimization solution alignment to the regression model through comparing neighborhoods can increase the accuracy of the optimization solution and the regression models through the comparison of historical data used to develop both of these components. As a result, the optimization solution can be used to control the operation of a system with a higher level of accuracy as compared to current systems. As a result, a computer system that controls a system can operate as a special purpose or improved computer system as compared to current computer systems that do use model optimizer 214 to generate an optimization solution for that system.

As depicted in the process described in this figure, if the optimization solution and the data area for the regression model are too far apart, then the neighborhood can be reselected based on the optimization solution to re-create the regression model and regenerate optimization solution. This iteration can occur until a desired level of accuracy occurs or until a desired level back soon occurs.

Computer system 212 can be configured to perform at least one of the steps, operations, or actions described in the different illustrative examples using software, hardware, firmware or a combination thereof. As a result, computer system 212 operates as a special purpose computer system in which model optimizer 214 in computer system 212 enables performing data driven optimization to generated optimization solutions that accurately reflect systems for which the optimization solutions are generated. In particular, model optimizer 214 transforms computer system 212 into a special purpose computer system as compared to currently available general computer systems that do not have model optimizer 214.

For example, optimization solutions generated by computer system 212 in the illustrative examples have a greater fidelity when used in reproducing the state or behavior of the real world system. In the illustrative examples, this greater fidelity can be achieved by iteratively creating regression models and optimization solutions such that the optimization solutions are within the neighborhood of the historical data points used to create the regression models. As a result, computer system 212 can use an optimization solution to operate a system in a manner that provides a desired output with a greater level of accuracy as compared to current systems for generating optimization solutions. In the illustrative examples, this accuracy of fidelity can be estimated based on the number of historical data points in the current neighborhood used to create the regression model that live within some acceptable distance of the optimization solution. In the illustrative examples, this distance is such that the optimization solution is considered to be within the current neighborhood.

The illustration of model environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, model optimizer 214 can continue to collect sensor data from sensors in add that additional sensor data to historical data 222. Further, model optimizer 214 can repeat their job process of generating optimization solution 204 at different periods of time. This repeating of the iterative process for generating optimization solution 204 can be performed to take into account situations in which changes are new to system 226. For example, equipment and assets will age. over time and new equipment may be purchased. Further, processes may be changed over time, processes may be added, and processes may be removed. Thus, optimization solution 204 can be updated dynamically and continuously based on receiving new data from system 226.

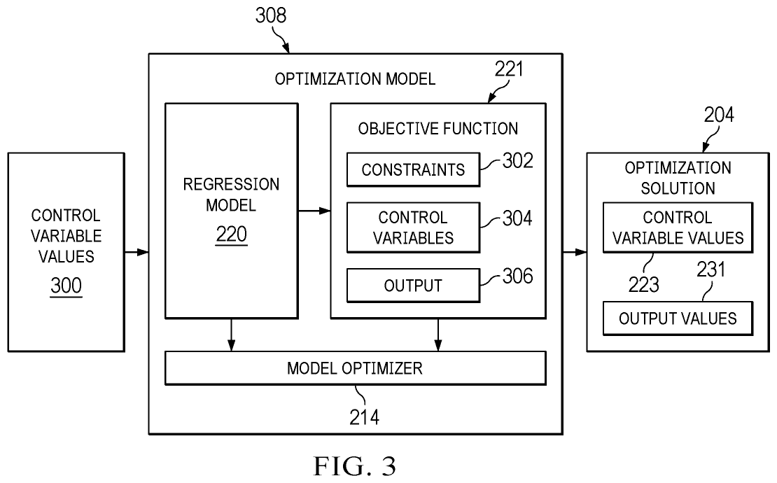

With reference now to FIG. 3, an optimization model used to generate an optimization solution is depicted in accordance with an illustrative embodiment. In this illustrative example, FIG. 3 illustrates generation of optimization solution 204 in FIG. 2. In the illustrative examples, the same reference numeral may be used in more than one figure. This reuse of a reference numeral in different figures represents the same element in the different figures.

As depicted, regression model 220, model optimizer 214, and objective function 221 can be in optimization model 308. In this example, objective function 221 is a mathematical function that defines an objective that relates to an output for a system. In this example, objective function 221 includes variables such as control variables 304 and output 306. Control variables 304 are associated with the objective defined for objective function 221. For example, objective function 221 can be used to define an objective of maximizing oil output in an oil plant. With this example, the system can be the oil plant, output 306 can be oil output of the oil plant, and control variables 304 can be flowrate, temperature, pressure, or variables that are associated with oil output of the oil plant.

Objective function 221 can also include constraints 302. Constraints 302 can be used to make outputs generated using objective function 221 meet constraints in the system. In this illustrative example, constraints 302 can be a predetermined range of values for control variables 304 and output 306, or upper and lower bounds for control variables 304 and output 306 defined by regression model 220. For example, constraints 302 can include a constraint on the maximum flowrate based on the equipment in the oil plant.

Regression model 220 can be a statistical process used to determine relationships between control variables 304 and output 306. Regression model 220 can comprise one or more equations that describe how output 306 varies with changes in control variables from control variables 304. In one illustrative example, regression model 220 can be implemented using machine learning model. In this example, regression model 220 can be used to predict values for output 306 based on values of control variables 304.

In this illustrative example, the relationships between control variables 304 and output 306 are determined using historical data points that includes values for control variables 304 and output 306. In this illustrative example, the historical data points can be examples of historical data points 229 or a portion of historical data points 229 in FIG. 2.

Model optimizer 214 includes an optimization algorithm that is used to identify values for control variables 304 in objective function 221 that minimize or maximize output 306 in objective function 221. In this depicted example, model optimizer 214 receives control variable values 300 and uses control variable values 300 to maximize or minimize output 306 by objective function 221 under conditions defined by constraints 302. Control variable values 300 are values for control variables 304 prior to performing optimization using model optimization system 202.

In this illustrative example, model optimizer 214 uses regression model 220, initial conditions such as control variable values 300, objectives defined by objective function 221, and constraints 302 related to operation conditions of system to provide results containing values for control variables 304 such that value for output 306 can be maximized or minimized subject to constraints defined by constraints 302. In this example, the results provided by model optimizer 214 is optimization solution 204.

Optimization solution 204 includes control variable values 223 and output value 231. Control variable values 223 are values for control variables 304 when value for output 306 is maximized or minimized. Output value 231 are extrama, which can be maximized or minimized values for output 306.

For example, objective function 221 can define an objective to maximize synthetic crude oil production in an oil sand plant while maintaining levels of intermediate products in storage tank. In this illustrative example, output 306 can be synthetic crude oil production and control variables 304 can include flowrate, density, temperature, pressure, and vibration.

In this example, regression model 220 can be created using either regression trees or multivariate adaptive regression splines techniques using a dataset containing sensor data collected for control variables 304 for a period of three years.

Optimization model 308 can include objective function 221 that takes multiple objectives into consideration. The objectives can be a linear combination of each individual objective multiplied by a weight.

For example, optimization model 308 can take three objectives into consideration. The first objective can be to maximize the throughput across all process outflows. In this illustrative example, Φ^{OMax} is outflows for all process outflows, and W_{i,b}^{O} is the weight associated with outflow i in period b.

A first objective maximizes the weighted sum of all process outflows Φ^{OMax} which can be expressed as:

Σ_{b=1}^{N}^{_{B}}Σ_{i∈Φ}_{^{O}}_{Max}f_{i,b}^{O}W_{i,b}^{O} (1)

where f_{i,b}^{O} is a function of outflow rates for outflow i in period b defined by market, engineering, or business objectives.

In addition, a second objective can be selected to maintain selected levels of inventory in the various tanks based on tank level targets that are specified in a production plan. The second objective minimizes the weighted sum of deviation from target levels for tanks. In this example, Φ^{T} is tanks, T_{t,b} is the target level of tank t at the end of period b, W_{t,b} is weight associated with tank t in period b and d_{t,b}≥0 is the absolute volume deviation variable of tank t in time-period b.

The objective function for the second objective can be expressed as:

Σ_{b=1}^{N}^{_{B}}Σ_{i∈Φ}_{^{T}}W_{t,b}d_{t,b} (2)

In another illustrative example, an extension of the second objective can also consider planned targets on production outflows and seek to minimize deviations from these targets. With this example, T_{i,b}^{O} is the target outflow rate of outflow i in period b, Φ^{OT} is tank outflow, W_{i,b}^{OT} is weight associated with outflow i in period b for outflow of tank t, and deviation variables rates d_{i,b}^{O}≥0 are defined as the absolute deviation from target of outflow i in period b.

The objective function for the second objective can be expressed as:

Σ_{b=1}^{N}^{_{B}}Σ_{i∈Φ}_{^{OT}}W_{i,b}^{OT}d_{i,b}^{O} (3)

In the illustrative example, a third objective can be used to minimize deviation in inflow variables Φ^{I} across time periods by reducing the differences in successive time periods. In this example, W_{i,b}^{I} is weight associated with inflow i in period b, and d_{i,b}^{I} is as the absolute difference between flow rate in time period b and that in b−1 for each inflow i and period b.

The objective function for the third objective can be expressed as:

Σ_{b=1}^{N}^{_{B}}Σ_{i∈Φ}_{^{I}}W_{i,b}^{I}d_{i,b}^{I} (4)

Objective function 221 can be a weighted sum of three objective functions, with positive weights for maximization functions and negative weights for the minimization functions. The relative weights for objective functions in this example are determined according to oil sand plant manager's priorities.

As depicted, constraints 302 can include an upper bound and a lower bound on the ratios between inflows and outflows. For example, the ratio of the flow f_{j,b} of product j, over the flow f_{i,b} of product i, can be defined within a specified range (F_{i,j}^{min},F_{i,j}^{max}), and:

$${f}_{j , b} \geq {F}_{i , j}^{min} {f}_{i , b} \& {f}_{j , b} \leq {F}_{i , j}^{max} {f}_{i , b} ∀ b ∈ 1 , … , {N}_{B} \qquad ( 5 )$$

where f_{j,b} is the flowrate for product j in period b, and f_{i,b} is the flowrate for product i in period b.

Constraints 302 can further include an upper bound and a lower bound on inventory changes between time periods. For any tank t from period b−1 to period b, increase of volume v is bounded by:

$${v}_{t , b} \leq {v}_{t , b - 1} + {Δ}^{U} {v}_{t}^{max} ∀ b ∈ 1 , … , {N}_{B} \qquad ( 6 )$$

wherein is Δ^{U}vₜ^{max} is an upper bound.

In addition, for any tank t from period b−1 to period b, a decrease of volume v is bounded by:

$${v}_{t , b} \geq {v}_{t , b - 1} + {Δ}^{D} {v}_{t}^{min} ∀ b ∈ 1 , … , {N}_{B} \qquad ( 7 )$$

wherein is Δ^{D}vₜ^{min} is a lower bound.

The illustration of the dataflow in FIG. 3 is provided as an example of one manner in which optimization solution 204 can be generated using model optimization system 202. This illustration is not meant to limit the manner in which other illustrative examples can be implemented. For example, output value 231 can also be determined using the process described above and can generate separately from optimization solution 204.

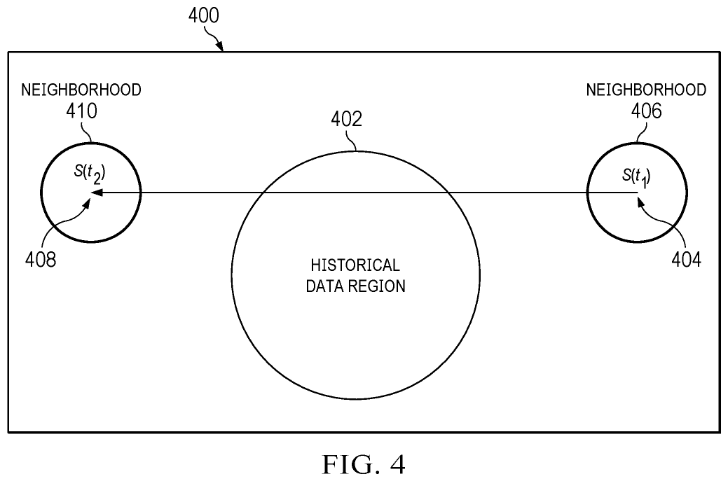

Turning now to FIG. 4, a diagram of neighborhoods used in an iterative process for generating an optimization solution is depicted in accordance with an illustrative embodiment. In this example, the selection of neighborhoods for creating regression models that are used to generate optimization solutions can be implemented in model optimization system 202 to generate optimization solution 204 in FIG. 2.

As depicted, historical data 400 comprises historical data collected for a real world physical system. In this example, historical data region 402 is a current neighborhood containing historical data used to generate a regression model such as regression model 220 in FIG. 2. In other words, the historical data points located within historical data region 402 are the data points used to create the regression model.

The regression model is used in an optimization system to generate an optimization solution. In this example, the optimization solution is located at S(t₁) 404. The location of the optimization solution at S(t₁) 404 can be determined using the control variable values and the output value. These values can be used as coordinates for locating the optimization solution within historical data 400.

As depicted, neighborhood 406 encompasses the optimization solution located at S(t₁) 404. In determining whether the optimization solution can be used, neighborhood 406 is compared to the current neighborhood, historical data region 402. As illustrated in this example, neighborhood 406 is not located within historical data region 402.

As a result, a new regression model is created using the historical data points in neighborhood 406. Neighborhood 406 becomes the current neighborhood because this neighborhood contains the historical data points are to create the current regression model. The prior regression model generated using the historical data points in historical data region 402 is no longer used.

This new regression model created using the historical data points in neighborhood 406 is used to create another optimization solution. In this example, the optimization solution is at S(t2) 408. Neighborhood 410 is selected around the optimization solution at S(t2) 408. The current neighborhood, neighborhood 406 is compared to the new neighborhood, neighborhood 410, encompassing the new optimization solution at S(t2) 408 to determine whether the new neighborhood is located within the current neighborhood. In this example, neighborhood 410 is not located within the current neighborhood, neighborhood 406.

As result, the iterative process continues by creating a regression model using the historical data points within neighborhood 410, generating another optimization solution, in determining whether the new neighborhood selected for that optimization solution is in the current neighborhood, neighborhood 410.

This process can continue until the new neighborhood is located within the current neighborhood. At that point, the optimization solution is a desirable optimization solution that can be used to control the operations of the system for which the optimization solution was generated.

In another illustrative example, the iterative process can be altered after some number of iterations. The optimization solution can then be used at that point. In another illustrative example, the new neighborhood for the optimization solution is not located within the current neighborhood for the regression model used create the optimization solution. Instead, an overlap can be present between the current neighborhood and the new neighborhood. In this instance, a determination is made as to whether historical data points are present in the overlap. If a sufficient number of historical data points is present, the iterative process can be terminated, and the optimization solution can be used. The number of historical data points can be determined a number of different ways. For example, statistical analysis can be used to determine when sufficient historical data points are present to obtain for the regression model that results in an optimization solution that can be considered to adequately model the system.

Additionally, the selection of the neighborhood for the optimization solution can be performed in a manner that reduces the possibility that the solution never converges such that new neighborhood is within the current neighborhood. For example, the region for the new neighborhood around the optimization solution can be selected based on the number of historical data points that are present. In another example, the size of the region can increase with each iteration. These and other techniques for selecting the new neighborhood for the optimization solution can be used in the illustrative examples.

In yet another illustrative example, a determination can be made as to whether the location of the optimization solution is within some distance of data points within the current neighborhood used to create the regression model from which the optimization solution was generated. Statistical analysis can be used to determine whether the location of the optimization solution relative to data points in the current neighborhood used to generate the regression model are sufficiently close such that the optimization solution is considered to be within the current neighborhood for purposes of determining whether to continue selecting new regions, creating ⁱregression models, and generating optimization solutions.

The illustration of historical data 400 in FIG. 4 is provided as a simplified view of historical data for purposes of explaining features in the different illustrative examples. As depicted, historical data 400 is shown in two dimensions when in actuality, hundreds or thousands of dimensions can be present because of the number of control variables. In this case, the location of neighborhoods becomes more complex. As a result, the number of dimensions can be reduced in the different illustrative examples.

For example, an embedding can be used to represent these multiple dimensions in a lower dimensional space. In other words, the high dimensional space of the control variables can be transformed into a lower dimensional space. The transformation is performed such that this lower dimensional representation has meaningful properties of the original data. The embedding can be performed using any currently available techniques for dimension reduction.

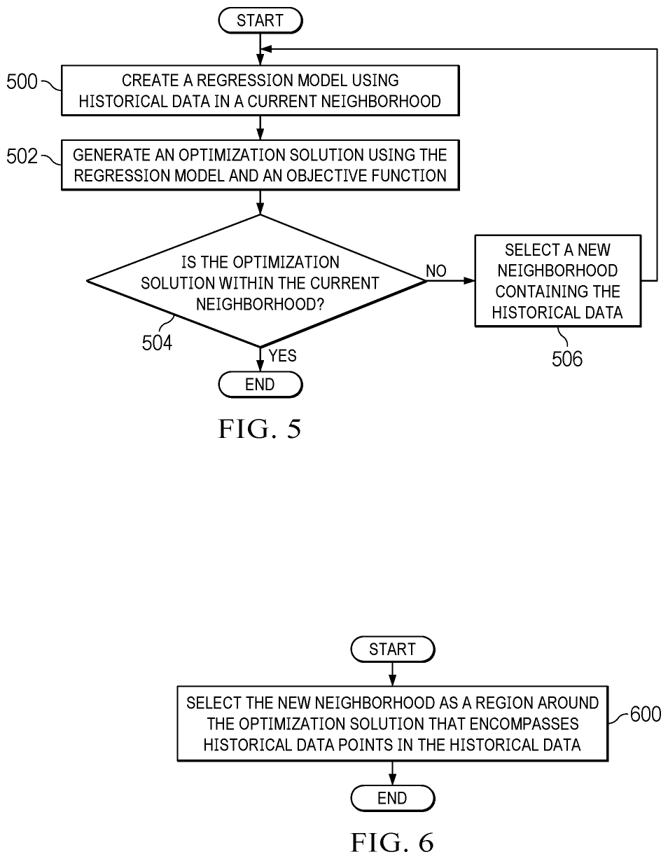

Turning next to FIG. 5, a flowchart of a process for data driven optimization is depicted in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in model optimizer 214 in computer system 212 in FIG. 2. In this illustrative example, the process is an iterative process that repeatedly generates regression models and optimization solutions using different neighborhoods to converge on an optimization solution that provides increased accuracy in the modeling of actual responses in a system.

The process begins by creating a regression model using historical data in a current neighborhood (step 500). In step 500, the historical data is for a system over time. The process generates an optimization solution using the regression model and an objective function (step 502). In this step, the optimization solution comprises control variable values for control variables in the objective function used to obtain an extrema as an output value of the objective function.

The process determines whether the optimization solution is within the current neighborhood (step of 504). If the optimization solution is within the current neighborhood, the process terminates. In this case, the optimization solution can be used in operating the system.

With reference again step 504, if the optimization solution is not within the current neighborhood, the process selects a new neighborhood containing the historical data (step 506). In this step, the new neighborhood is based on the optimization solution and becomes the current neighborhood. The process then returns to step 500 to iteratively repeat steps 500 to 504 while the optimization solution is not within the current neighborhood used to create the regression model. In other words, the process repeats the creating, generating, determining, and selecting steps in response to the optimization solution not being within the current neighborhood.

As a result, this process can be repeated until the optimization solution converges to located within the current neighborhood used to create the regression model from which the optimization model is generated. In other illustrative examples, an additional determination can be made when the optimization solution is not within the current neighborhood in step 504. For example, a determination can be made as to whether some number of iterations through the process has occurred. If the number of iterations is greater than some threshold, the process can terminate.

Turning next to FIG. 6, a flowchart of a process for selecting a new neighborhood is depicted in accordance with an illustrative embodiment. The process illustrated in this flowchart is an example of one implementation for step 506 in FIG. 5.

The process selects the new neighborhood as a region around the optimization solution that encompasses historical data points in the historical data (step 600). The process terminates thereafter. The optimization solution is a center of the new neighborhood. In this example, the region can be selected to encompass a number of the historical data points that results in the regression model generates predictions within a threshold value when making the predictions using test data.

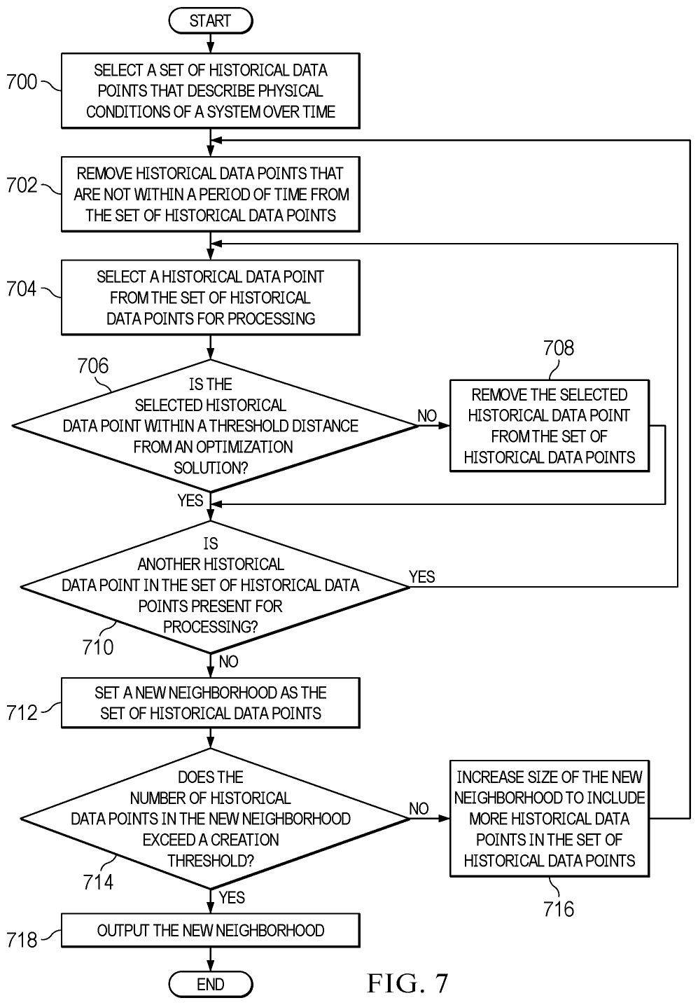

With reference to FIG. 7, a flowchart of a process for selecting a new neighborhood in accordance with an illustrative embodiment. The process in FIG. 7 can be implemented in hardware, software, or both. When implemented in software, the process can take the form of program instructions that are run by one of more processor units located in one or more hardware devices in one or more computer systems. For example, the process can be implemented in model optimizer 214 in model optimization system 202 in FIG. 2. The process in FIG. 7 is an example of one implementation for step 506 in FIG. 5.

The process begins by selecting a set of historical data points that describe physical conditions of a system over time (step 700). In this illustrative example, historical data points in the set of historical data points include control variable values, output value, and non-control variable values for physical conditions of the system at different times indicated by timestamps associated with the datapoints. These historical data points can be processed to select a new neighborhood for the optimization solution. In this illustrative example, the set of historical data points can be selected using the optimization solution.

The process removes historical data points that are not within a period of time from the set of historical data points (step 702). In step 702, the period of time can be, for example, 2 days, 5 weeks, 3 months, 2 years, or any period of time from current timestamp to a timestamp in the past. In this example, historical data points not within the period of time may no longer accurately reflect the physical condition of the system. In other words, the process can remove older historical data points such that the remaining historical data points in the set of historical data points more accurately reflect the system.

The process selects a historical data point from the set of historical data points for processing (step 704). The process determines whether the selected historical data point is within a threshold distance from an optimization solution (step 706).

In step 706, the distance between the selected historical data point and the optimization solution is a mathematical distance that is a measure of the similarity between the selected historical data point and the optimization solution. In other words, the distance between the selected historical data point and the optimization solution can be used to determine whether the selected historical data point and the optimization solution share common features that describe the physical condition of the system. In this example, the distance between the selected historical data point and the optimization solution can be determined using Euclidean distance, Manhattan distance, or any suitable method that measures mathematical distance between two points.

In this illustrative example, the process can measure the distance between the selected historical data point and optimization solution in an embedding space of historical data points. The embedding space is a collection of historical data points that are represented by values in vectors. The historical data points can be converted to vectors using dimensionality reduction techniques to reduce number of variables describing the historical data points while preserving the original relationships between data points in the historical data points. Examples of dimensionality reduction techniques include principal component analysis, t-Distributed Stochastic Neighbor Embedding, and word2vec.

With reference again to step 706, if the selected historical data point is not within the threshold distance from the optimization solution, the process removes the selected historical data point from the set of historical data points (step 708). The process determines whether another historical data point in the set of historical data points is present for processing (step 710). With reference again to step 706, if the selected historical data point is within the threshold distance from the optimization solution, the process also proceeds to step 710.

In step 710, if all of the historical data points from the set of historical data points have not been selected for processing, the process returns to step 704 as described above. Otherwise, the process sets the new neighborhood as the set of historical data points (step 712).

The process determines whether the number of historical data points in the new neighborhood exceeds a creation threshold (step 714). If the number of historical data points in the new neighborhood exceeds the creation threshold, the process outputs the new neighborhood (step 718). The process terminates thereafter. In step 718, the creation threshold can be a number of historical data points that provides a desired level of accuracy in creating a regression model. This creation threshold can be selected in a number of different ways. For example, statistical methods with respect to regression models and accuracy can be used to determine how many historical data points are used.

With reference again to step 714, if the number of historical data points in the new neighborhood does not exceed the creation threshold, the process increases size of the new neighborhood to include more historical data points in the set of historical data points (step 716). The process returns to step 702 and repeats step 702 to step 716 until the number of historical data points in the new neighborhood exceeds the creation threshold. The increase in the size of the neighborhood can occur repeatedly such that at some point the entire historical data set is used to create the regression model and to generate the optimization solution.

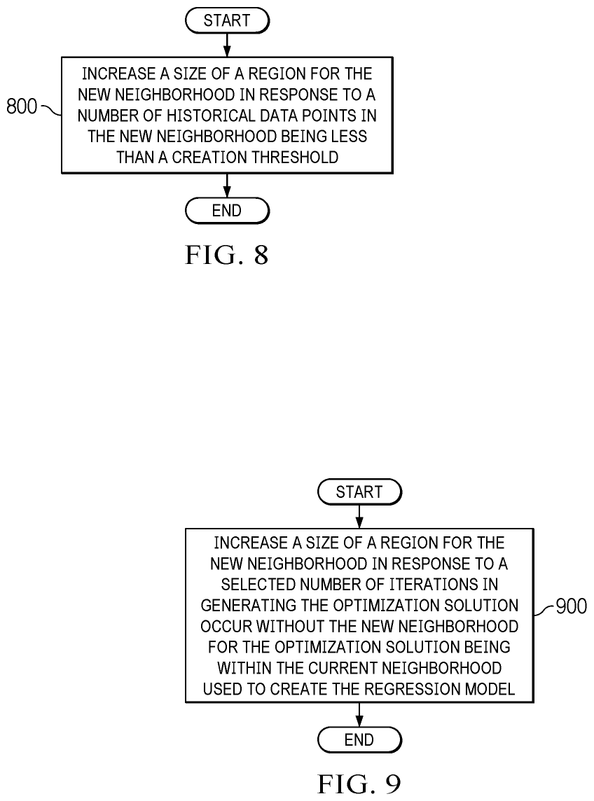

With reference now to FIG. 8, a flowchart of a process for changing a region size for a new neighborhood is depicted in accordance with an illustrative embodiment. The process in FIG. 8 is an example of another implementation for step 506 in FIG. 5.

The process increases a size of a region for the new neighborhood in response to a number of historical data points in the new neighborhood being less than a creation threshold (step 800). The process terminates thereafter.

Increasing size of the new neighborhood in step 800 can reduce the likelihood that the optimization solution does not converge to have the same neighborhood as the neighborhood used to create the regression model that was used to generate the optimization solution.

In FIG. 9, a flowchart of a process for changing a region size for a new neighborhood is depicted in accordance with an illustrative embodiment. The process in FIG. 9 is an example of yet another implementation for step 506 in FIG. 5.

The process increases a size of a region for the new neighborhood in response to a selected number of iterations in generating the optimization solution occur without the new neighborhood for the optimization solution being within the current neighborhood used to create the regression model (operation 900). The process terminates thereafter.

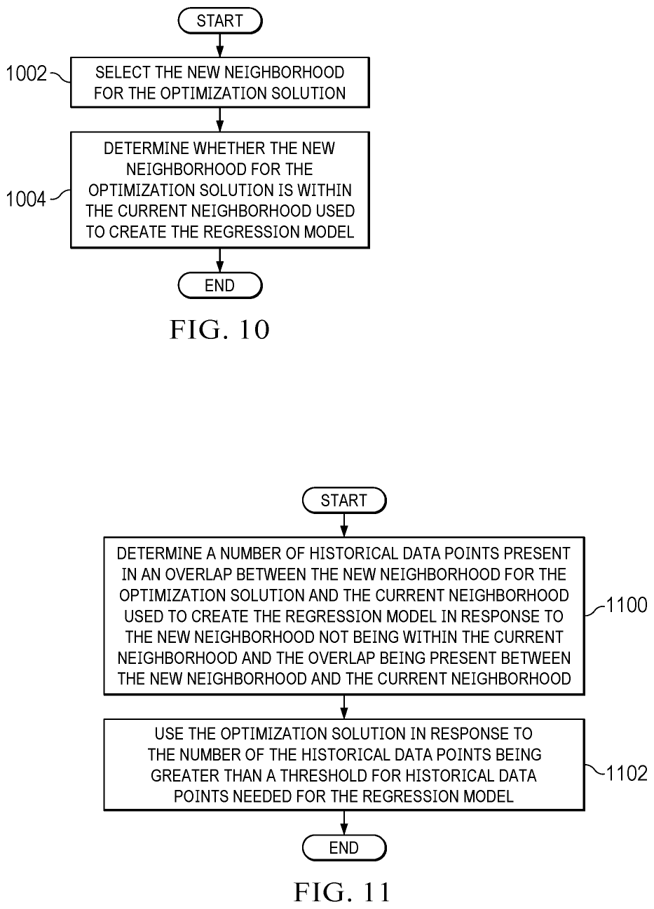

Turning to FIG. 10, a flowchart of a process for determining whether an optimization solution is within a current neighborhood is depicted in accordance with an illustrative embodiment. The process illustrated in FIG. 10 is an example of an implementation for step 504 in FIG. 5.

The process selects the new neighborhood for the optimization solution (step 1000). The process determines whether the new neighborhood for the optimization solution is within the current neighborhood used to create the regression model (step 1002). The process terminates thereafter.

With reference next to FIG. 11, a flowchart of a process for determining whether an optimization solution is within a current neighborhood is depicted in accordance with an illustrative embodiment. The process illustrated in FIG. 11 is an example of additional steps that can be performed with the process in FIG. 10 in implementing step 504 in FIG. 5.

The process determines a number of historical data points present in an overlap between the new neighborhood for the optimization solution and the current neighborhood used to create the regression model in response to the new neighborhood not being within the current neighborhood and the overlap being present between the new neighborhood and the current neighborhood (step 1100). The process uses the optimization solution in response to the number of the historical data points being greater than a threshold for historical data points needed for the regression model (step 1102). The process terminates thereafter. This threshold can be determined using statistical processes that identify the number of historical data points that may be needed in the overlap portion for the regression model to be used for the optimization solution.

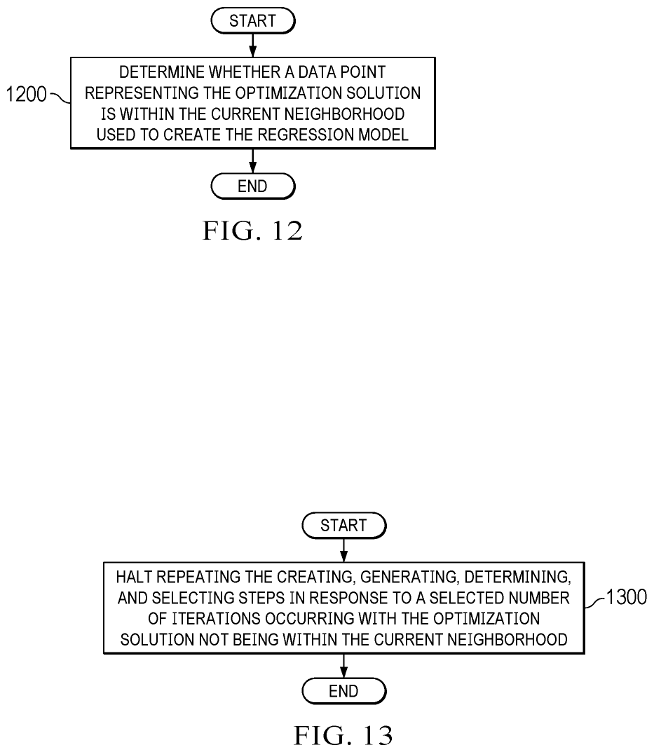

With reference next to FIG. 12, a flowchart of a process for determining whether an optimization solution is within a current neighborhood is depicted in accordance with an illustrative embodiment. The process illustrated in FIG. 11 is an example of additional steps that can be performed with the process in FIG. 10 in implementing step 504 in FIG. 5.

The process can determine whether a data point representing the optimization solution is within the current neighborhood used to create the regression model (step 1200). In this example, the data point is comprised of the controlled variable values and the output value for the optimization solution.

With reference now to FIG. 13, a flowchart of a process for repulsing iterations in generating optimization solutions is depicted in accordance with an illustrative embodiment. The process illustrated in FIG. 13 is an example of an additional step that can be performed with the steps in FIG. 5.

The process halts repeating the creating, generating, determining, and selecting steps in response to a selected number of iterations occurring with the optimization solution not being within the current neighborhood (step 1300). The process terminates thereafter. In this example, these steps are step 500, step 502, step 504, and step 506. As a result, the maximum number of iterations can be controlled to allow the process of finding the optimization solution.

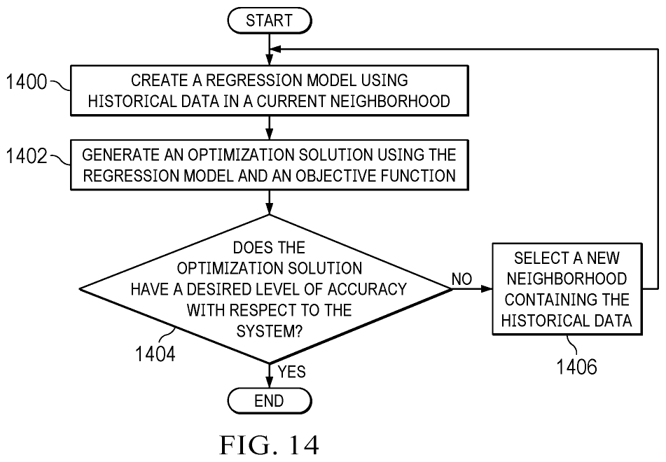

Turning next to FIG. 14, a flowchart of a process for data driven optimization is depicted in accordance with an illustrative embodiment. The process in FIG. 14 can be implemented in hardware, software, or both. When implemented in software, the process can take the form of program instructions that are run by one of more processor units located in one or more hardware devices in one or more computer systems. For example, the process can be implemented in model optimizer 214 in computer system 212 in FIG. 2. In this illustrative example, the process is an iterative process that repeatedly creates regression models and optimization solutions using different neighborhoods to converge on an optimization solution that provides increased accuracy in modeling the actual responses in a system.

The process begins by creating a regression model using historical data in a current neighborhood (step 1400). In step 1400, the historical data is for a system over time. The process generates an optimization solution using the regression model and an objective function (step 1402). In this step, the optimization solution comprises control variable values for control variables in the objective function used to obtain an extrema as an output value of the objective function.

The process determines whether the optimization solution has a desired level of accuracy with respect to the system (step 1404). In step 1404, this determination can be made using a fidelity analysis. The fidelity for the optimization solution is the degree to which the optimization solution reproduces the state or behavior of a real-world system or condition. In other words, fidelity is a measure of the realism of the optimization solution for a system.

In one illustrative example, the fidelity analysis can be made as to the degree to which the optimization solution reproduces the state and behavior of the system. In another illustrative example, the fidelity analysis can be made by comparing output of the objective function to actual output from system by implementing the optimization solution to the real-world system. This desired level accuracy can be a determination as to whether the optimization solution is within a tolerance or threshold of actual system operation over the embedded space.

The desired level of accuracy can also be estimated in terms of the number of historical data points in the current neighborhood that lie within a threshold of acceptable distance in the embedded space relative to the optimization solution. When this number is sufficiently large, as determined by comparison against a predefined parameter that denotes an acceptable number of such data points, then the optimization solution is considered to be satisfying the desired level of accuracy.

If the optimization solution has the desired level of accuracy, the process terminates. In this case, the optimization solution can be used to operate the system.

With reference again step 1404, if the optimization solution does not have a desired level accuracy, the process selects a new neighborhood containing the historical data (step 1406). In this step, the new neighborhood is based on the optimization solution and becomes the current neighborhood. The process then returns to step 1400 to iteratively repeat steps 1400 to 1404 while the optimization solution does not have a desired level of accuracy.

In this flowchart in FIG. 14, the process repeats the creating, generating, determining, and selecting steps in response to the optimization solution not having a desired level of accuracy. In another illustrative example, the process can both determine whether the optimization solution has a desired level of accuracy and whether the optimization solution is within the current neighborhood used to create the regression model.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

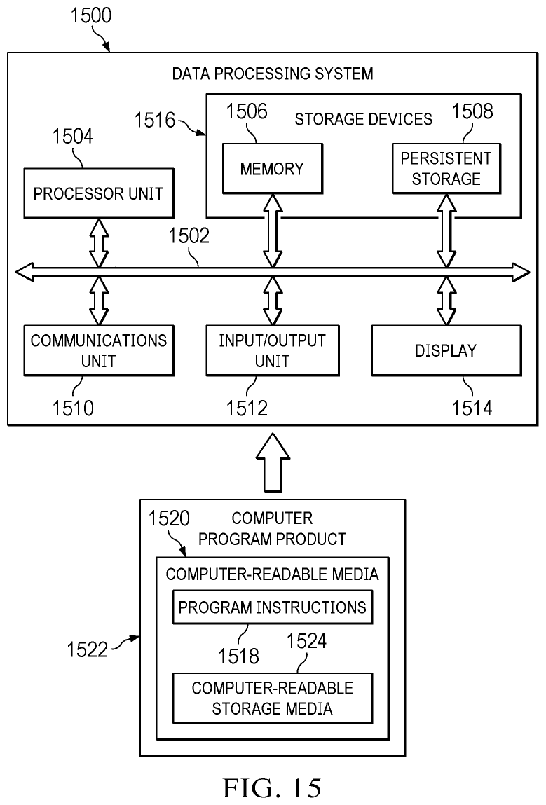

Turning now to FIG. 15, a block diagram of a data processing system is depicted in accordance with an illustrative embodiment. Data processing system 1500 can be used to implement computers and computing devices in computing environment 100 in FIG. 1. Data processing system 1500 can also be used to implement computer system 212 in FIG. 2. In this illustrative example, data processing system 1500 includes communications framework 1502, which provides communications between processor unit 1504, memory 1506, persistent storage 1508, communications unit 1510, input/output (I/O) unit 1512, and display 1514. In this example, communications framework 1502 takes the form of a bus system.

Processor unit 1504 serves to execute instructions for software that can be loaded into memory 1506. Processor unit 1504 includes one or more processors. For example, processor unit 1504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1504 can may be implemented using one or more heterogeneous processor systems in which a main processor is present with secondary processors on a single chip. As another illustrative example, processor unit 1504 can be a symmetric multi-processor system containing multiple processors of the same type on a single chip.

Memory 1506 and persistent storage 1508 are examples of storage devices 1516. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1516 may also be referred to as computer readable storage devices in these illustrative examples. Memory 1506, in these examples, can be, for example, a random-access memory or any other suitable volatile or non-volatile storage device. Persistent storage 1508 may take various forms, depending on the particular implementation.

For example, persistent storage 1508 may contain one or more components or devices. For example, persistent storage 1508 can be a hard drive, a solid-state drive (SSD), a flash memory, a rewritable optical disk, a rewritable magnetic tape, or some combination of the above. The media used by persistent storage 1508 also can be removable. For example, a removable hard drive can be used for persistent storage 1508.

Communications unit 1510, in these illustrative examples, provides for communications with other data processing systems or devices. In these illustrative examples, communications unit 1510 is a network interface card.

Input/output unit 1512 allows for input and output of data with other devices that can be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs can be located in storage devices 1516, which are in communication with processor unit 1504 through communications framework 1502. The processes of the different embodiments can be performed by processor unit 1504 using computer-implemented instructions, which may be located in a memory, such as memory 1506.

These instructions are referred to as program instructions, computer usable program instructions, or computer readable program instructions that can be read and executed by a processor in processor unit 1504. The program instructions in the different embodiments can be embodied on different physical or computer readable storage media, such as memory 1506 or persistent storage 1508.

Program instructions 1518 are located in a functional form on computer readable media 1520 that is selectively removable and can be loaded onto or transferred to data processing system 1500 for execution by processor unit 1504. Program instructions 1518 and computer readable media 1520 form computer program product 1522 in these illustrative examples. In the illustrative example, computer readable media 1520 is computer readable storage media 1524.

Computer readable storage media 1524 is a physical or tangible storage device used to store program instructions 1518 rather than a medium that propagates or transmits program instructions 1518. Computer readable storage media 1524, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1518 can be transferred to data processing system 1500 using a computer readable signal media. The computer readable signal media are signals and can be, for example, a propagated data signal containing program instructions 1518. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1520” can be singular or plural. For example, program instructions 1518 can be located in computer readable media 1520 in the form of a single storage device or system. In another example, program instructions 1518 can be located in computer readable media 1520 that is distributed in multiple data processing systems. In other words, some instructions in program instructions 1518 can be located in one data processing system while other instructions in program instructions 1518 can be located in one data processing system. For example, a portion of program instructions 1518 can be located in computer readable media 1520 in a server computer while another portion of program instructions 1518 can be located in computer readable media 1520 located in a set of client computers.

The different components illustrated for data processing system 1500 are not meant to provide architectural limitations to the manner in which different embodiments can be implemented. In some illustrative examples, one or more of the components may be incorporated in or otherwise form a portion of, another component. For example, memory 1506, or portions thereof, may be incorporated in processor unit 1504 in some illustrative examples. The different illustrative embodiments can be implemented in a data processing system including components in addition to or in place of those illustrated for data processing system 1500. Other components shown in FIG. 15 can be varied from the illustrative examples shown. The different embodiments can be implemented using any hardware device or system capable of running program instructions 1518.

Thus, illustrative embodiments of the present invention provide a computer implemented method, computer system, and computer program product for data driven optimization. A number of processor units creates a regression model using historical data in a current neighborhood. The historical data is for a system over time. The number of processor units generates an optimization solution using the regression model and an objective function. The number of processor units determines whether the optimization solution is within the current neighborhood. The number of processor units selects a new neighborhood containing the historical data in response to the optimization solution not being within the current neighborhood. The new neighborhood is based on the optimization solution and becomes the current neighborhood. The number of processor units repeats the creating, generating, determining, and selecting steps in response to the optimization solution not being within the current neighborhood. According to other illustrative embodiments, a computer system and a computer program product for data driven optimization are provided. As a result, the illustrative embodiments generate an optimization solution using an iterative process based on whether the optimization solution is in the same neighborhood as the neighborhood used to create the regression model in a manner that increases the accuracy and confidence in the optimization solution.

The different illustrative examples provide an improved approach to determining optimization solutions through using regression models in the optimization process to generate the optimization solutions. In this manner, interdependencies between regression models and optimization models can be maintained in the illustrative example in a manner that increases the accuracy of the optimization model and the regression models through an iterative process in which comparisons of neighborhoods for the regression models and optimization models are made. In the different illustrative examples, the process of creating a regression model and an optimization solution using the regression model can result in the optimization solution being within the neighborhood of the regression model. In some cases, the entire data set of historical data may be used for the regression model in generating the optimization solution.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for data driven optimization, the computer implemented method comprising:
creating, by a number of processor units, a regression model using historical data in a current neighborhood, wherein the historical data is for a system over time;
generating, by the number of processor units, an optimization solution using the regression model created from the current neighborhood and an objective function;
determining, by the number of processor units, whether the optimization solution is within the current neighborhood;
selecting, by the number of processor units, a new neighborhood containing the historical data in response to the optimization solution not being within the current neighborhood, wherein the new neighborhood is based on the optimization solution and becomes the current neighborhood; and
repeating, by the number of processor units, the creating the regression model, generating the optimization solution, determining whether the optimization solution is within the current neighborhood, and selecting the new neighborhood in response to the optimization solution not being within the current neighborhood.

2. The computer implemented method of claim 1, further comprising:
halting repeating, by the number of processor units, the creating, generating, determining, and selecting steps in response to a selected number of iterations occurring with the optimization solution not being within the current neighborhood.

3. The computer implemented method of claim 1, wherein selecting, by the number of processor units, the new neighborhood containing the historical data further comprises:
selecting, by the number of processor units, the new neighborhood as a region around the optimization solution that encompasses historical data points in the historical data, wherein the optimization solution is a center of the new neighborhood.

4. The computer implemented method of claim 3, wherein the region is selected to encompass a number of the historical data points that results in the regression model generating predictions within a threshold value when making the predictions using test data.

5. The computer implemented method of claim 1, wherein selecting, by the number of processor units, the new neighborhood containing the historical data neighborhood comprises:
increasing, by the number of processor units, a size of a region for the new neighborhood in response to a number of historical data points in the new neighborhood being less than a creation threshold.

6. The computer implemented method of claim 1, wherein selecting, by the number of processor units, the new neighborhood containing the historical data comprises:
increasing, by the number of processor units, a size of a region for the new neighborhood in response to a selected number of iterations in generating the optimization solution occurring without the new neighborhood for the optimization solution being within the current neighborhood used to create the regression model.

7. The computer implemented method of claim 1, wherein determining, by the number of processor units, whether the optimization solution is within the current neighborhood further comprises:
selecting, by the number of processor units, the new neighborhood for the optimization solution; and
determining, by the number of processor units, whether the new neighborhood for the optimization solution is within the current neighborhood used to create the regression model.

8. The computer implemented method of claim 7 further comprising:
determining, by the number of processor units, a number of historical data points present in an overlap between the new neighborhood for the optimization solution and the current neighborhood used to create the regression model in response to the new neighborhood not being within the current neighborhood and the overlap being present between the new neighborhood and the current neighborhood; and
using, by the number of processor units, the optimization solution in response to the number of the historical data points being greater than a threshold for historical data points needed for the regression model.

9. The computer implemented method of claim 1, wherein determining, by the number of processor units, whether the optimization solution is within the current neighborhood further comprises:
determining, by the number of processor units, whether a data point for the optimization solution is within the current neighborhood used to create the regression model.

10. A computer system comprising:
a number of processor units, wherein the number of processor units executes program instructions to:
create a regression model using historical data in a current neighborhood, wherein the historical data is for a system over time;
generate an optimization solution using the regression model created from the current neighborhood and an objective function;
determine whether the optimization solution is within the current neighborhood;
select a new neighborhood containing the historical data in response to the optimization solution not being within the current neighborhood, wherein the new neighborhood is based on the optimization solution and becomes the current neighborhood; and
repeat the creating the regression model, generating the optimization solution, determining whether the optimization solution is within the current neighborhood, and selecting the new neighborhood in response to the optimization solution not being within the current neighborhood.

11. The computer system of claim 10, wherein the number of processor units further executes program instructions to:
halt repeating, by the number of processor units, generating the optimization solution, determining whether the optimization solution is within the current neighborhood, and selecting the new neighborhood in response to a selected number of iterations occurring with the optimization solution not being within the current neighborhood.

12. The computer system of claim 10, wherein in selecting the new neighborhood containing the historical data, the number of processor units further executes program instructions to:
select the new neighborhood as a region around the optimization solution that encompasses historical data points in the historical data, wherein the optimization solution is a center of the new neighborhood.

13. The computer system of claim 12, wherein in determining whether the optimization solution is within the current neighborhood, the number of processor units further executes program instructions to:
determine whether a data point for the optimization solution is within the current neighborhood used to create the regression model.

14. The computer system of claim 10, wherein in selecting the new neighborhood containing the historical data neighborhood, the number of processor units further executes program instructions to:
increase a size of a region for the new neighborhood in response to a number of historical data points in the new neighborhood being less than a creation threshold.

15. The computer system of claim 10, wherein in selecting the new neighborhood containing the historical data, the number of processor units further executes program instructions to:
increase a size of a region for the new neighborhood in response to a selected number of iterations in generating the optimization solution occurring without the new neighborhood for the optimization solution being within the current neighborhood used to create the regression model.

16. The computer system of claim 10, wherein in determining whether the optimization solution is within the current neighborhood, the number of processor units further executes program instructions to:
select the new neighborhood for the optimization solution; and
determine whether the new neighborhood for the optimization solution is within the current neighborhood used to create the regression model.

17. The computer system of claim 16, the number of processor units further executes program instructions to:
determine whether a number of historical data points present in an overlap between the new neighborhood for the optimization solution and the current neighborhood used to create the regression model in response to the new neighborhood not being within the current neighborhood and the overlap being present between the new neighborhood and the current neighborhood; and
use the optimization solution in response to the number of the historical data points being greater than a threshold for historical data points needed for the regression model.

18. The computer system of claim 10, wherein in determining whether the optimization solution is within the current neighborhood, the number of processor units further executes program instructions to:
determine whether a data point for the optimization solution is within the current neighborhood used to create the regression model.

19. A computer program product for data driven optimization, the computer program product comprising a computer readable storage medium having program instructions embodied therewith, the program instructions executable by a computer system to cause the computer system to:
create a regression model using historical data in a current neighborhood, wherein the historical data is for a system over time;
generate an optimization solution using the regression model created from the current neighborhood and an objective function;
determine whether the optimization solution is within the current neighborhood;
select a new neighborhood containing the historical data in response to the optimization solution not being within the current neighborhood, wherein the new neighborhood is based on the optimization solution and becomes the current neighborhood; and
repeat the creating the regression model, generating the optimization solution, determining whether the optimization solution is within the current neighborhood, and selecting the new neighborhood in response to the optimization solution not being within the current neighborhood.

20. The computer program product of claim 19, wherein in selecting the new neighborhood containing the historical data, the program instructions executable by the computer system further cause the computer system to:
select the new neighborhood as a region around the optimization solution that encompasses historical data points in the historical data, wherein the optimization solution is a center of the new neighborhood.
